(19) United States
(12) Patent Application Publication
(10) Pub. No.: US 2015/0185017 A1
(43) Pub. Date: Jul. 2, 2015

(54) Image-based geo-hunt

(71) Applicant: Gregory L. Kreider, Lyndeborough, NH (US)

(72) Inventors: Gregory L. Kreider, Lyndeborough, NH (US); Mark Edward Sabalauskas, Cambridge, MA (US)

(73) Assignee: Gregory L. Kreider, Lyndeborough, NH (US)

(21) Appl. No.: 14/544,342

(22) Filed: Dec. 24, 2014

Related U.S. Application Data
(60) Provisional application No. 61/964,271, filed on Dec. 28, 2013.

(51) Int. Cl. G01C 21/00; G06K 9/46; G06T 3/00; G06T 3/40; G06K 9/00; G06K 9/62; G06T 3/60

(52) U.S. Cl. CPC G01C 21/005; G06K 9/6202; G06K 9/4604; G06K 9/4652; G06T 3/60; G06T 3/40; G06K 9/6212; G06K 9/6215; G06K 9/00671; G06T 3/0006

(57) ABSTRACT

During a communication technique, an image and information specifying a location of an electronic device when the image was captured are received. Then, a reference image, associated with a second location (which is at least proximate to the location), in a predefined set of one or more reference images is accessed. These predefined set of one or more reference images are associated with a set of one or more locations along a geographic route that includes the second location. Moreover, the image is compared to the reference image. If the comparison indicates a match between the image and the reference image, a message is provided indicating that a milestone in navigating the geographic route has been achieved. Otherwise, a second message is provided indicating that the milestone in navigating the geographic route has not been achieved.

### CROSS-REFERENCE TO RELATED APPLICATION

This application claims priority under 35 U.S.C. §119(e) to U.S. Provisional Application Ser. No. 61/964,271, entitled “Image-Based Geo-Hunt,” by Gregory L. Kreider and Mark E. Sabalauskas, Attorney docket number GK-1301, filed on Dec. 28, 2014, the contents of which are herein incorporated by reference.

### BACKGROUND

The present disclosure relates to a technique for providing feedback about whether a milestone has been achieved during navigation along a geographic route.

Geo-hunts are an increasingly popular activity in which individuals attempt to navigate a set of one or more locations along a geographic route. During a geo-hunt, individuals are often tasked with acquiring images of objects at the set of one or more locations to prove that they successfully navigated the geographic route.

However, it can be tedious, time-consuming and expensive to examine the images acquired by the individuals to determine if the individuals actually completed a given geo-hunt. Moreover, because of variations in lighting conditions, orientations of image sensors or cameras, perspectives from which the images are acquired, etc., it can be difficult to accurately determine if the images are indeed of the objects. Furthermore, existing approaches to geo-hunts are susceptible to fraud, because it is often unclear when the images were acquired. This may allow some individuals to use previously acquired images of at least some of the objects, which is frustrating to the other participants and can degrade the overall user experience.

### SUMMARY

The disclosed embodiments relate to a computer system that provides feedback. During operation, the computer system receives an image and information specifying a location of an electronic device when the image was captured. Then, the computer system accesses a reference image, associated with a second location, in a predefined set of one or more reference images stored in a computer-readable memory based on the location, where the predefined set of one or more reference images are associated with a set of one or more locations along a geographic route that includes the second location, and the location is at least proximate to the second location. Moreover, the computer system compares the image to the reference image. If the comparison indicates a match between the image and the reference image, the computer system provides a message indicating that a milestone in navigating the geographic route has been achieved. Otherwise, the computer system provides a second message indicating that the milestone in navigating the geographic route has not been achieved.

Note that the information specifying the location may be based on: a local positioning system, a global position system, triangulation, trilateration, and/or an address, associated with the electronic device, in a network. Moreover, the information may specify: an orientation of the electronic device when the image was acquired, and/or a direction of the electronic device when the image was acquired. Prior to the comparison, the computer system may use the information to modify the image to correct for: a light intensity, a location of a light source, color variation (or shifts) in the image, the orientation of the electronic device, the direction of the electronic device, natural changes based on a difference between a timestamp associated with the image and a timestamp associated with the reference image, and/or a difference in a composition of the image and a composition of the reference image.

In some embodiments, prior to the comparison, the computer system image processes the image to extract features, where the comparison is based on the extracted features. Alternatively or additionally, the information may specify at least some of the features in the image. Note that the features may include: edges associated with objects, corners associated with the objects, lines associated with objects, conic shapes associated with objects, color regions within the image, and/or texture associated with objects. The comparing may involve applying a threshold to the extracted edges to correct for variation in intensity in the image and the reference image.

Furthermore, prior to the comparison, the computer system may select pixels associated with a wavelength of light in the image and/or a distribution of wavelengths of light in the image, where the comparison is based on the selected pixels.

Additionally, the location may be the same as or different than the second location.

In some embodiments, the comparing involves: rotating the image so that the orientation of the image matches an orientation of the reference image; scaling the image so that a length corresponding to first features in the image matches a second length corresponding to second features in the reference image; extracting the first features from the image; calculating a similarity metric between the first features and the second features; and determining if the match is achieved based on the similarity metric and a threshold.

Note that the comparing may involve transforming a representation of the image from rectangular coordinates to log-polar coordinates.

Moreover, the message may specify information associated with a subsequent location in the set of one or more locations and/or the second message may include instructions on how to acquire another image of the location to obtain the match.

In some embodiments, the computer system provides a third message that indicates a competitive state of another member of a group navigating the geographic route. Alternatively or additionally, the third message may offer an opportunity to purchase a hint that includes: instructions on how to navigate the geographic route; instructions on how to acquire another image of the location to obtain the match; and/or information associated with a subsequent location in the set of one or more locations.

Furthermore, prior to the receiving, the computer system receives the set of reference images and the associated set of one or more locations along the geographic route. Alternatively or additionally, prior to the receiving, the computer system receives metadata associated with the set of reference images.

Another embodiment provides a method that includes at least some of the operations performed by the computer system.

Another embodiment provides a computer-program product for use with the computer system. This computer-program product includes instructions for at least some of the operations performed by the computer system.

### BRIEF DESCRIPTION OF THE FIGURES

FIG. 1 is a flow chart illustrating a method for providing feedback in accordance with an embodiment of the present disclosure.

FIG. 2 is a flow chart illustrating the method of FIG. 1 in accordance with an embodiment of the present disclosure.

FIG. 3A is a drawing illustrating a user interface in an image-based geo-hunt application in accordance with an embodiment of the present disclosure.

FIG. 3B is a drawing illustrating a user interface in an image-based geo-hunt application in accordance with an embodiment of the present disclosure.

FIG. 3C is a drawing illustrating a user interface in an image-based geo-hunt application in accordance with an embodiment of the present disclosure.

FIG. 3D is a drawing illustrating a user interface in an image-based geo-hunt application in accordance with an embodiment of the present disclosure.

FIG. 3E is a drawing illustrating a user interface in an image-based geo-hunt application in accordance with an embodiment of the present disclosure.

FIG. 4 is a block diagram illustrating a system that performs the method of FIGS. 1 and 2 in accordance with an embodiment of the present disclosure.

FIG. 5 is a block diagram illustrating a computer system that performs the method of FIGS. 1 and 2 in accordance with an embodiment of the present disclosure.

FIG. 6 is a block diagram illustrating a data structure for use with the computer system of FIG. 5 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

Embodiments of a computer system, a technique for providing feedback, and a computer-program product (e.g., software) for use with the computer system are described. During this communication technique, an image and information specifying a location of an electronic device when the image was captured are received. Then, a reference image, associated with a second location (which is at least proximate to the location), in a predefined set of one or more reference images is accessed. These predefined set of one or more reference images are associated with a set of one or more locations along a geographic route that includes the second location. Moreover, the image is compared to the reference image. If the comparison indicates a match between the image and the reference image, a message is provided indicating that a milestone in navigating the geographic route has been achieved. Otherwise, a second message is provided indicating that the milestone in navigating the geographic route has not been achieved.

By providing the feedback, the communication technique may accurately and efficiently alert an individual that is attempting to navigate the geographic route whether or not a milestone has been achieved. Consequently, the communication technique may reduce the time and expense associated with determining whether or not the individual has successfully navigated the geographic route. In addition, the communication technique may reduce incidents of fraud, such as when a previously acquired image is received. In these ways, the communication technique may reduce frustration of participants in events (such as geo-hunts) and may improve the overall user experience.

In the discussion that follows, a user may include: an individual or a person (for example, an existing customer, a new customer, a service provider, a vendor, a contractor, etc.), an organization, a business and/or a government agency. Furthermore, a ‘business’ should be understood to include: for-profit corporations, non-profit corporations, organizations, groups of individuals, sole proprietorships, government agencies, partnerships, etc.

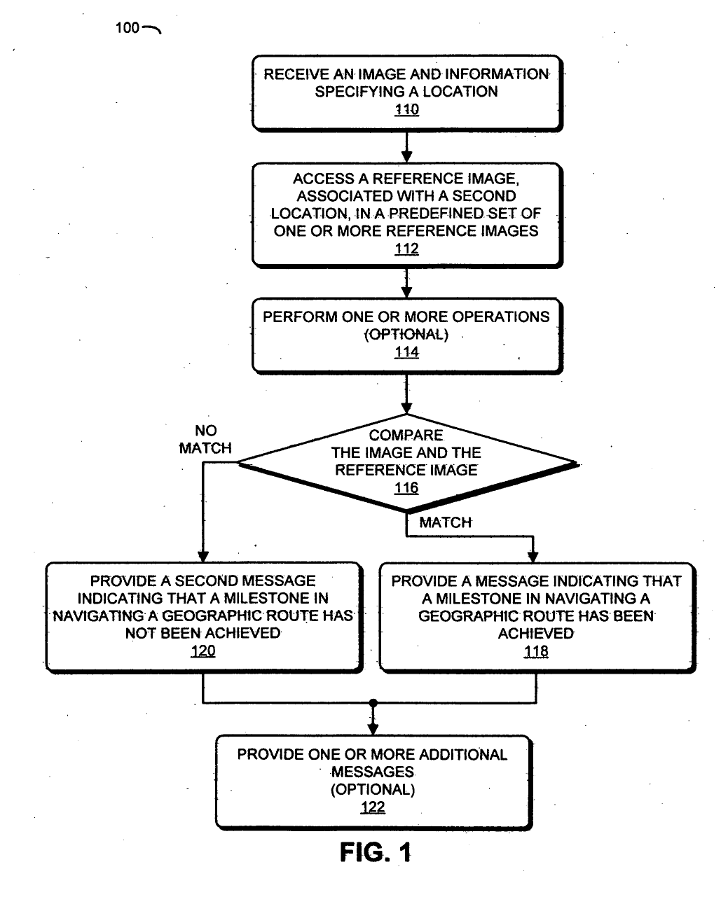

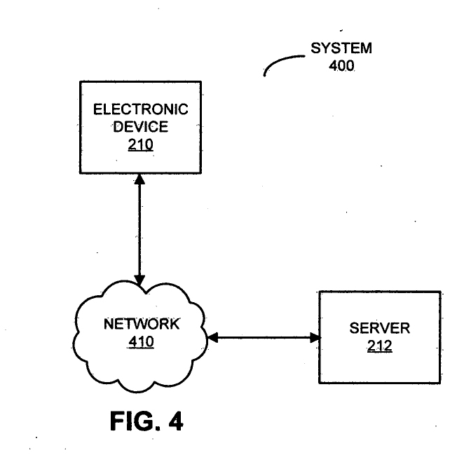

We now describe embodiments of the communication technique. FIG. 1 presents a flow chart illustrating a method 100 for providing feedback, which may be performed by a computer system (such as computer system 400 in FIG. 4). During operation, the computer system receives an image and information specifying a location (operation 110) of an electronic device when the image was captured. Note that the information specifying the location may be based on: a local positioning system, a global position system, triangulation, trilateration, and/or an address, associated with the electronic device, in a network (such as a static Internet Protocol address). Alternatively or additionally, the information specifying the location may indirectly specify the location, such as the time when the image was acquired, the time when the image is submitted, and/or an altitude of the electronic device. For example, a user of a portable electronic device (such as a cellular telephone) may upload the image to the computer system. This image may have been acquired using a camera in the cellular telephone, and the information specifying the location may be determined based on communication between the cellular telephone and a wireless network (such as a cellular-telephone network or a wireless local area network).

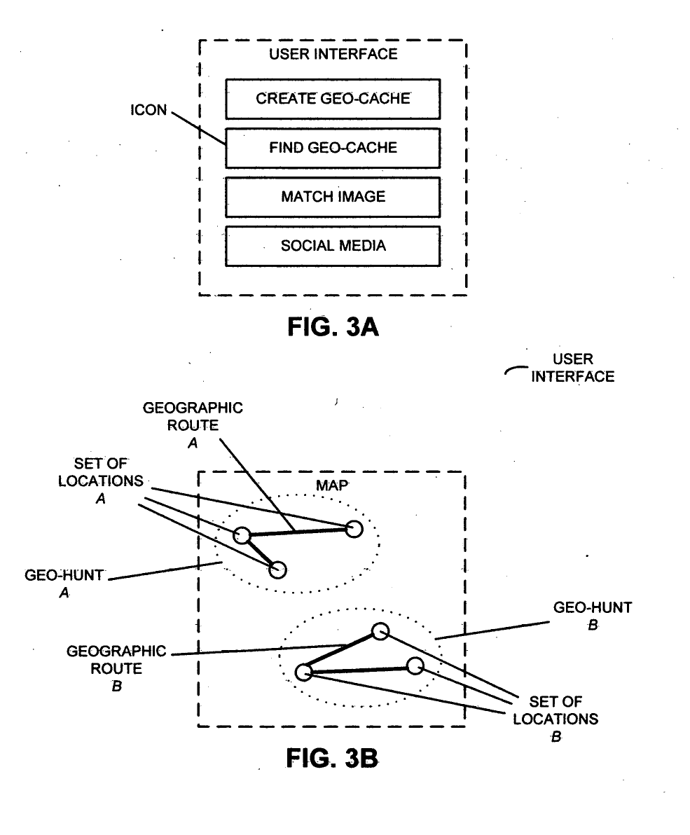

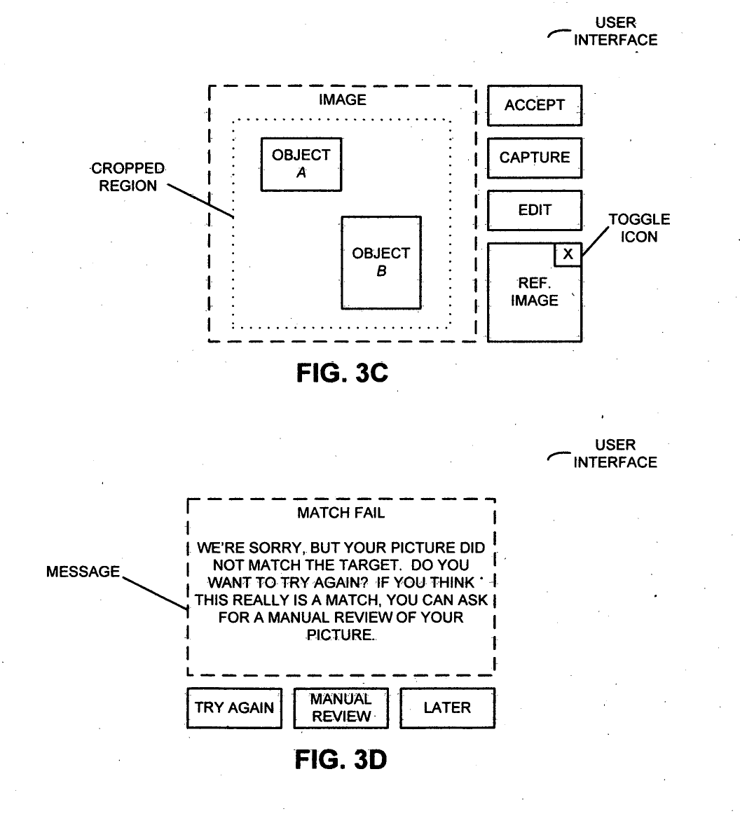

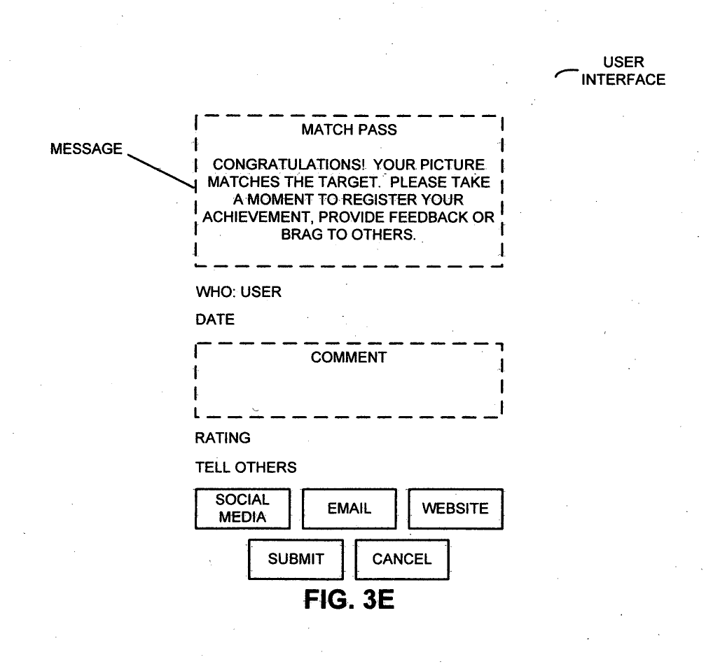

Then, the computer system accesses a reference image, associated with a second location, in a predefined set of one or more reference images (operation 112) stored in a computer-readable memory based on the location, where the predefined set of one or more reference images are associated with a set of one or more locations along a geographic route that includes the second location, and the location is at least proximate to the second location. As described further below with reference to FIG. 3, in an exemplary embodiment the set of one or more locations along the geographic route define a geo-hunt (which is sometimes referred to as an ‘image-based geo-hunt’ because it is based on acquired images at locations as opposed to acquiring physical objects). Consequently, the predefined set of one or more reference images and the associated set of one or more locations is sometimes referred to as a ‘geo-cache,’ which may be provided by an individual, an organization or a company when defining the geographic route. Moreover, note that the location may be the same as or different than the second location. For example, the location and the second location may provide different views or perspectives of an object, such as a building or a natural landmark. Thus, the location may be proximate, in the vicinity of, or in the neighborhood of the object.

In some embodiments, the computer system optionally performs one or more operations (operation 114). In particular, the computer system may image process the image to extract features (and a subsequent comparison operation 116 may be based on the extracted features). For example, the features may be extracted using a description technique, such as: scale invariant feature transform (SIFT), speed-up robust features (SURF), a binary descriptor (such as ORB), binary robust invariant scalable keypoints (BRISK), fast retinal keypoint (FREAK), etc. Alternatively or additionally, the information may specify at least some of the features in the image and/or the reference image may include additional information specifying at least some features in the reference image (i.e., at least some of the features may have be previously identified or extracted). Note that the features may include: edges associated with objects in the image and/or the reference image, corners associated with the objects, lines associated with objects, conic shapes associated with objects, color regions within the image, and/or texture associated with objects.

Alternatively or additionally, the information may specify: an orientation of the electronic device when the image was acquired, and/or a direction of the electronic device when the image was acquired. For example, the information may be provided by an accelerometer and/or a magnetometer (such as a compass). In these embodiments, the one or more optional operations 114 may include modifying the image to correct for: a light intensity, a location of a light source, color variation (or shifts) in the image, the orientation of the electronic device, the direction of the electronic device (i.e., the perspective), natural changes based on a difference between a timestamp associated with the image and a timestamp associated with the reference image (e.g., the image and the reference image may have been acquired at different times of day or different times of the year), a difference in a composition of the image and a composition of the reference image (e.g., the vegetation in the background may be different or one or more persons may be in the image and/or the reference image), and/or cropping of the image from a larger image (either prior to the receiving or during the comparison). In some embodiments, the information associated with the image includes a time when the image was submitted.

Furthermore, the one or more optional operations 114 may include selecting pixels associated with a wavelength of light in the image and/or a distribution of wavelengths of light in the image (and the subsequent comparison operation 116 may be based on the selected pixels). For examples, the pixels output by a CCD or CMOS imaging sensor in a camera that acquired the image may include pixels associated with a red-color filter, pixels associated with a blue-color filter, and pixels associated with a green-color filter, and a subset of the pixels (such as those associated with a red-color filer may be selected). Alternatively or additionally, color planes may be separated out from the image. Note that the color filtering may be used to avoid spoofing attempts in which a user attempts to provide a preexisting image of the location (instead of navigating to the location and acquiring the image). In some embodiments, histogram comparisons based on the distribution of pixel values per color or luminance plane are used. Additionally, watermarks may be included in the image and/or the reference image to ensure authenticity (and to make sure the reference image is not submitted as the image in an attempt to obtain a match).

Next, the computer system compares the image to the reference image (operation 116). The comparing (operation 116) may involve applying a threshold to the extracted edges to correct for variation in intensity in the image and/or the reference image. Alternatively or additionally, the comparing (operation 116) may involve: rotating the image so that the orientation of the image matches an orientation of the reference image; scaling the image so that a length corresponding to first features in the image matches a second length corresponding to second features in the reference image; extracting the first features from the image; calculating a similarity metric between the first features and the second features; and determining if a match is achieved based on the similarity metric and a threshold (e.g., if the similarity metric is greater than the threshold, a match may be achieved). In some embodiments, the comparing (operation 116) involves transforming a representation of the image and/or the reference image from rectangular coordinates to log-polar coordinates. In these embodiments, the rectangular and the log-polar representations may have a common center point. In addition to the information included in the image, a match in the comparison (operation 116) may also be based on the time the image was acquired or submitted and/or additional or extra information (such as the altitude, etc.). Thus, a match may also require that the location where the image was acquired be close to or proximate to (such as within 100 meters) or a reference location or metadata associated with a reference image using in the comparison. Similarly, a match may also involve that the image be acquired or submitted with a time window (such as 30 min. or an hour, or at sunrise the next day) of a previous location in the geo-hunt.

If the comparison indicates a match between the image and the reference image (operation 116), the computer system provides a message indicating that a milestone in navigating the geographic route has been achieved (operation 118). Otherwise (operation 116), the computer system provides a second message indicating that the milestone in navigating the geographic route has not been achieved (operation 120). For example, the message may specify information associated with a subsequent location in the set of one or more locations and/or the second message may include instructions on how to acquire another image of the location to obtain the match.

In some embodiments, the computer system optionally provides one or more additional messages (operation 122). For example, the computer system may provide a third message that indicates a competitive state of another member of a group navigating the geographic route (i.e., attempting to duplicate or match the reference image). Alternatively or additionally, the third message may offer an opportunity to purchase a hint that includes: instructions on how to navigate the geographic route; instructions on how to acquire another image of the location to obtain the match; and/or information associated with a subsequent location in the set of one or more locations. For example, the information about the subsequent location may only be partial or, instead of revealing the subsequent location, metadata associated with (and which characterizes) the subsequent location may be provided. In some embodiments, the third message includes information (such as a symmetric or an asymmetric encryption key) used to decrypt the next location or goal in the geo-hunt.

In some embodiments, the reference image, the location and/or associated metadata is time released. For example, the object, target or milestone may only be revealed after a given hour date. Similarly, there may be a time limit placed on when individuals following or navigating the geographic route can submit a match.

After a successful match (operation 116), a user may submit feedback or additional metadata (such as the time of the match) to the computer system. This may allow the first person who found the object, target or milestone to be identified. Alternatively, a match may be registered on the computer system as soon as the comparison is completed (along with a timestamp when the match was obtained).

A variety of revenue models may be associated with the communication technique. For example, the hint in the third message may be sold to a user by a provider of the communication technique. Similarly, the user may purchase information about the subsequent location. Moreover, the basic service in the communication technique may be free, but the user may be able to access one or more additional geo-caches or geographic routes for a fee. In some embodiments, revenue is associated with promotions and/or dynamic/temporal advertising (which may leverage the proximity of the location to businesses).

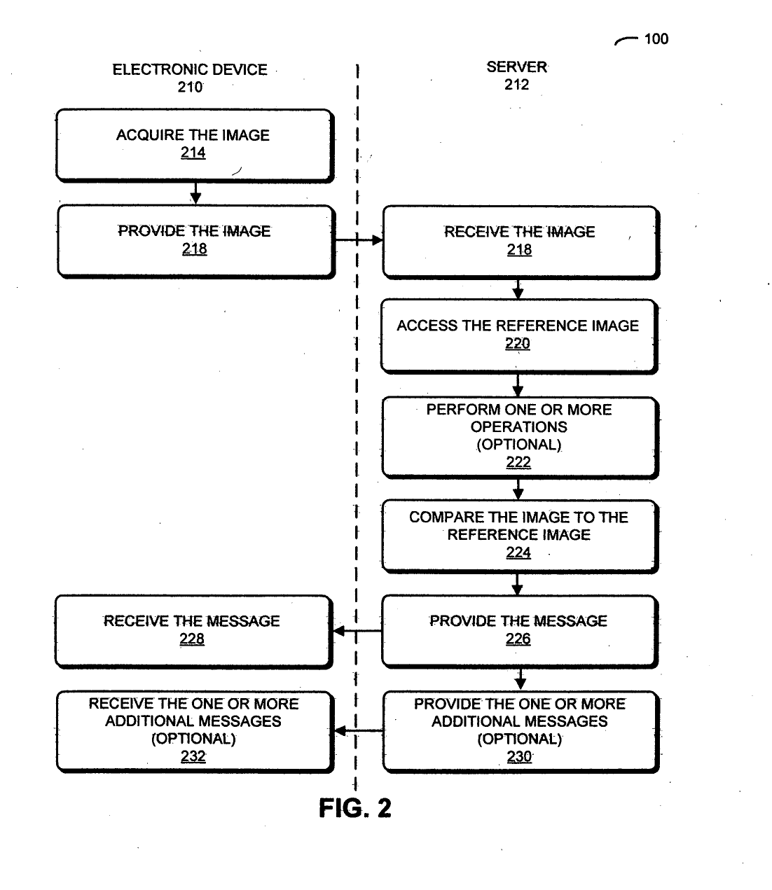

In an exemplary embodiment, the communication technique is implemented using an electronic device (such as a computer or a portable electronic device, e.g., a cellular telephone) and a computer, which communicate through a network, such as a cellular-telephone network and/or the Internet (e.g., using a client-server architecture). This is illustrated in FIG. 2, which presents a flow chart illustrating method 100 (FIG. 1).

During the method, a user of electronic device 210 (such as a cellular telephone or a digital camera) may acquire the image (operation 214) at the location. Then, electronic device 210 may provide the image (operation 216), as well as the information specifying the location, the orientation of electronic device 210 when the image was acquired, and/or a direction of electronic device 210 when the image was acquired. Moreover, server 212 may receive the image (operation 218) and may note the time of submission (which may be provided by electronic device 210 and/or independently determined by server 212).

In response to receiving the image (operation 218), server 212 may access the reference image (operation 220) in the predefined set of one or more reference images based on the location. Moreover, server 212 may optionally perform the one or more operations (operation 222), such as: image processing the image to extract the features, modifying the image, and/or selecting the pixels associated with the wavelength of light in the image or a distribution of wavelengths of light in the image.

Next, server 212 may compare the image to the reference image (operation 224). For example, server 212 may: apply the threshold to the extracted edges, rotate the image, scale the image, extract the first features from the image, calculate the similarity metric between the first features and the second features in the image, determine if the match is achieved based on the similarity metric and the threshold, and/or transform the representation of the image.

Furthermore, server 212 may provide the message (operation 226), which is received by electronic device 210 (operation 228). If the comparison indicates a match between the image and the reference image (operation 224), the message may indicate that the milestone in navigating the geographic route has been achieved. Otherwise, the message may indicate that the milestone in navigating the geographic route has not been achieved and/or remedial action that the user can take.

In some embodiments, server 212 optionally provides the one or more additional messages (operation 230), which are received by electronic device 210 (operation 232). These one or more additional messages may indicate the competitive state of another individual participating in the geo-hunt and/or may provide the hint.

In some embodiments of method 100 (FIGS. 1 and 2), there may be additional or fewer operations. For example, referring back to FIG. 1, instead of accessing the reference image (operation 112), prior to the receiving (operation 110) the computer system may receive the set of reference images and the associated set of one or more locations (or targets) along the geographic route. In the case of a geo-hunt, the set of references images and the associated set of one or more locations may be received from an organizer of the geo-hunt or an individual that defines the geo-hunt. Thus, the geo-hunt may be defined or specified by a different person or organization that the individual(s) who actually perform the geo-hunt. Alternatively or additionally, prior to the receiving (operation 110), the computer system may receive metadata (such as descriptions of the set of one or more locations or instructions on how to find the set of one or more locations) associated with the set of reference images. These operations of receiving the set of reference images and the associated set of one or more locations, and/or the metadata may be performed in a separate method than method 100 (FIGS. 1 and 2).

Furthermore, in some embodiments extra information (such as the time the image is acquired, the altitude of the electronic device, communication connections to proximate electronic devices, etc.) is received along with or separately from the image in operation 110 in FIG. 1. As noted previously, this extra information may be used during the comparison in operation 116 in FIG. 1 to determine whether or not there is a match.

In addition, the data for the locations in the geo-hunt may be encrypted and downloaded to the electronic device before the geo-hunt begins. Then, the locations may be revealed sequentially or all at once (depending on the type of geo-hunt that has been defined or set up). This may prevent participants in the geo-hunt from preparing beforehand if the geo-hunt is competitive or involves a competition. This approach may also reduce the communication bandwidth of server 212 (FIG. 2) if timing during the geo-hunt is important.

In some embodiments, the image includes a unique signature that identifies the electronic device that was used to acquire it. Moreover, image processing of the image and/or the comparing (operation 116) may be performed, in whole or in part, on the electronic device and/or the computer system.

Additionally, in some embodiments optional operations are performed before operation 110 in FIG. 1. For example, a user of electronic device 110 may first communicate with server 212 and chooses a target location. Server 212 may sends information about the target location to electronic device 110, and the user may attempt to go or navigate to the target location. Along the way, the user may request additional information, which server 212 may send (such as the third message). Once the user is at the location, they may acquire the image and submit it (i.e., in operation 110 in FIG. 1).

Furthermore, the order of the operations may be changed, and/or two or more operations may be combined into a single operation. For example, the third message in operation 122 in FIG. 1 or operation 230 in FIG. 2 may be provided before receiving the image and the information specifying the location in operation 110 in FIG. 1 or operations 214 and 218 in FIG. 2. Note that operations 114 and 116 may transform the image into information that can be used to facilitate the comparison with the reference image, and thus constitute a technical effect.

In an exemplary embodiment, the communication technique is used to facilitate a so-called geo-hunt, in which users attempt to navigate a geographic route to locate a set of milestones. For example, the geo-hunt may include a scavenger hunt or a tour through locations of interest in a geographic region (such as retracing a historical event). In some embodiments, the geo-hunt may be conducted using a so-called ‘story mode,’ in which targets or milestones are released to users stage by stage to tell a story.

FIGS. 3A-3G illustrate user interfaces in an image-based geo-hunt application, which may be displayed on electronic device 210 in FIG. 2. This geo-hunt application may be used by one or more individuals to acquire and to provide images to a system, which, as described further below with reference to FIG. 4, performs at least some of the operations in the communication technique.

FIG. 3A presents an initial user interface with icons that can be activated or selected by a user of the geo-hunt application. If the user activates the ‘create geo-cache’ icon, an image view from an image sensor in electronic device 210 (FIG. 2) is displayed. The user can acquire the image (by activating an image-capture icon), crop the image as desired, and then accept the image. In addition, the user can provide a description (such as metadata) about the image. Then, the image, as well as the location, the orientation and/or the direction, may be provided to server 212 (FIG. 2) for use as a reference image in a geo-cache.

Subsequently, the user or another user may select or activate the ‘find geo-cache’ icon. As shown in FIG. 3B, in response the geo-cache application may display a map showing geo-caches with a set of nearby locations to a current location of electronic device 210 (FIG. 2), as well as a currently active geo-cache that the user is trying to navigate.

The user or the other user may also select or activate the ‘match image’ icon. As shown in FIG. 3C, in response the geo-cache application may allow the user or the other user to acquire another image. In particular, an image view from an image sensor in electronic device 210 (FIG. 2) may be displayed, and a reference image may also be optionally displayed (based on an on/off toggle button or icon) to assist the user in choosing the content, orientation and framing of the image The user may acquire the image (by activating the image-capture icon), crop the image as desired, and then accept the image. In addition, the user can provide a description (such as metadata) about the image. Then, the image, as well as the location, the orientation and/or the direction, may be provided to server 212 (FIG. 2) for use as the image. This image may be compared to the reference image (either manually or automatically) during the communication technique.

As shown in FIG. 3D, if a match is not obtained, the user or the other user may receive a ‘failure message’ with feedback and/or instructions on how to obtain an improved image and/or a hint as to where the location is relative to the user's or the other user's current location. Alternatively, as shown in FIG. 3E, if the match is obtained, the user or the other user may receive a ‘pass message’ with instructions or information about the next location or milestone in the geographic path.

Furthermore, the user or the other user may also select or activate the ‘social media’ icon. In response, the geo-cache application may allow the user or the other user to communicate with other users that are participating in geo-hunts.

In an exemplary embodiment, the matching of the image and the reference image may involve selecting from multiple variables (such as position, rotation, scale, perspective) so that strong features in the image and/or the reference image are used, thereby reducing the amount of data that needs to be processed. These strong features in the image and/or the reference image may be aligned. If a coarse match is obtained, a full-match calculation may be performed.

In particular, the matching may involve image preparation, such as: converting red-green-blue (RGB) information to greyscale by extracting the luminance signal. For example, a color image may be converted into a black-and-white image. In an exemplary embodiment, the image has a JPEG format so that the black-and-white and the color information are embedded in it. Then, the image may be smoothed using a low-pass filter (such as an average over a small 3×3 or 5×5 pixel area) to reduce noise. Moreover, color analysis may be performed to determine color information. This color analysis may be performed globally in the image or locally over a small area with a histogram of pixel values per RGB color plane, which may allow different colored regions in the image to be identified.

Next, feature detection may be performed. This may allow a few interesting points or features in the image to be identified. In particular, the features may include: edges (which highlight object boundaries), corners, straight lines, textures (which characterize repetitive regions), and/or high-frequency structures (such as bricks, leaves, etc.) in local areas of the image (e.g., by measuring the density of edges, the self-similarity of the image over a small region, or the statistics of pixel distributions). In some embodiments, edges are detected using an adaptive threshold (e.g., the threshold may be selected so that only the most significant edges are kept). Alternatively or additionally, lines may be detected using a Radon transform with an adaptive threshold so that the strongest lines are kept.

Furthermore, coarse alignment may be performed. This may allow the interesting points or features in the image to be match with those of the reference image (or those in a set of reference images). The coarse alignment may only involve checking the properties (such as luminance and color) proximate to a feature so the analysis can be performed quickly. In some embodiments, the coarse alignment may be fine-tuned based on the neighborhood surrounding or proximate to the features in the image and/or the reference image.

Additionally, a log-polar mapping may be performed around each feature. In particular, because x, y translations in polar coordinates can be complicated, the mapping may be centered at the same point in the image and the reference image. This may be included in the coarse-alignment operation. Then, the log-polar mapping may provide rotational and scale invariance.

Note that the similarity between the two mapped images (such as the image and the reference image) may be determined using the raw image or one or more of the features (such as edges). For example, a correlation may be performed, and if the value is large enough, a match may be declared. In an exemplary embodiment, if enough lines in the image and the reference image are correlated (such as 10-25 lines), a match is declared. In some embodiments, a match may be based on other criteria, such as colors or textures.

In an exemplary embodiment, the matching of the image and the reference image may involve the following operations. Edge detection may be performed on the image and the reference image to identify sharp differences in intensity (such as greater than 0.8 on a relative normalized scale), i.e., the strongest points may be selected. For example, a canny edge detector or an edge detector based on a convolution kernel and with an adaptive threshold may be used.

Then, line segments may be detected. For example, starting from a point from the edge detector, adjacent points may be traced. While doing this, linear regression may be performed, and when the correlation coefficient drops below a predefined level (such as 0.3 or 0.1), the tracing may cease. This approach may split gradual curves into several line segments. After determining the line segments, those that are separated by small gaps may be combined (in case there is noise in a given image). After this operation, for each line segment, the endpoints and the equation of a line are known.

Next, two images are compared by picking the most-significant line segments (e.g., the longest) and determining the translation, rotation and/or scaling needed to make them match. This operation can be repeated for some or all of the remaining line segments and to see how many agree (within an uncertainty, such as 1-10%). Although, the number of comparisons grows with the square of the number of line segments, usually there are not too many, and the calculations on the line parameters can be performed in an acceptable amount of time.

If enough line segments agree (such as more than 5, 10 or 20 line segments), the images are either accepted as a match or, as described further below, additional checks are performed.

Moreover, the image being analyzed may be split into different regions based on grey-scale luminosity and/or color. For example, the colors in an image may be quantized, and the number of different values may be reduced (such as to 10-100 different color values). The median cut may split a histogram of color values into bins of approximately equal size (treating each of the three color planes separately). Alternatively, k-means clustering may be used. In this technique, a number of random color points are selected, each pixel is iteratively assigned to one of these points. Then, the point is moved to the center of mass of the pixels assigned to it, until the points stabilize. In another approach, local minima in the histogram of each color plane are identified.

Next, different regions between the images are compared to determine the translation, rotation and/or scaling needed to align them. For example, patches of similar area around the periphery of the image being analyzed may be characterized. In particular, a given patch may be classified by the average intensity over the pixels it contains (such as by using three levels: dark, mid, and light) using the quantized colors and/or the raw data. The sequence of classifications for each image may be compared to determine if one can be shifted to match the other (i.e., the necessary rotation). Assuming that the image centers are roughly aligned, note that the size of the patch determines the angular resolution available.

Furthermore, information about each quantized region may be compared. Note that the information may include: size, center of mass, eccentricity and orientation to the x axis, and/or density (i.e., the number of pixels in the region divided by the size of the bounding box around the region). If sufficient regions are similar (such as at least 30-70%), a match is declared, and the translation, rotation and/or scaling is determined from the best fit of the centers of mass of the regions. As in one-dimensional analysis, this may involve looking at each pair of regions. However, if 30-60 color values are quantized, this analysis may be tractable.

Additionally, the boundaries between quantized regions may be examined for features. For example, ‘fingers’ of one region that project into another may be identified. Note that a finger may be well-defined. In particular, it may be long and pointed, narrowing at one end and wide at the other. Alternatively, the adjacency count may be used, which is the number of pixels of a first region that are next to a pixel of second region. If the adjacency count is low, then may indicate that there is a clean, well-defined border between the two regions. Similarly, if the adjacency count is high, then it may be likely that the two regions are stippled over each other.

Once again, similarities in these measures or metrics in the two images may be calculated and, if found, translation, rotation and/or scaling to match the images may be derived. Alternatively, a mismatch is declared.

Note that if a rough match (in terms of translation, scaling and rotation) is found, another confirmation operation may be used. In particular, one image may be translated, rotated and/or scaled the other image. Then, the two images are corrected. The match is rejected if the correlation is too low (such as less than 0.3-0.7). Moreover, the color of the quantized image regions may be compared. This may compensate for color differences based on the lighting, time of day or year, and weather. However, this depends on the stability of the quantization technique. For example, similar regions may need to be aligned, and they may need to be the same size so that the dominant color can be compared.

In some embodiments, instead of or in addition to sub-dividing analyzing the grey-scale luminosity and/or the color values of different regions, a Hough transform for line/segment detection and/or texture filters are used.

Note that matching based on line segments may be used for urban scenes or indoors (e.g., in a location where the images have strong edges). The grey-scale luminosity and/or color-value analysis may be used for natural scenes.

We now describe embodiments of a system and the computer system, and their use. FIG. 4 presents a block diagram illustrating a system 400 that can be used, in part, to perform operations in method 100 (FIGS. 1 and 2). In this system, during the communication technique a user of electronic device 210 may use a software product, such as a software application that is resident on and that executes on electronic device 210. (Alternatively, the user may interact with a web page that is provided by server 212 via network 410, and which is rendered by a web browser on electronic device 210. For example, at least a portion of the software application may be an application tool that is embedded in the web page, and which executes in a virtual environment of the web browser. Thus, the application tool may be provided to the user via a client-server architecture.) This software application may be a standalone application or a portion of another application that is resident on and which executes on electronic device 210 (such as a software application that is provided by server 212 or that is installed and which executes on electronic device 210).

During the communication technique, the user may use the software application on electronic device 210 to acquire the image at the location. For example, the user may active a virtual icon (such as a graphical object displayed on a touchscreen), which may cause a digital camera in electronic device 210 to acquire the image. Then, the software application may instruct electronic device 210 to communicate the image, as well as the information, to server 212 via network 410.

After receiving the image and the information, server 212 may access the reference image in the predefined set of one or more reference images based on the location. Moreover, server 212 may optionally perform the one or more operations (operation 222).

Next, server 212 may compare the image to the reference image (operation 224).

Furthermore, server 212 may provide the message to electronic device 210 via network 410. For example, if the comparison indicates a match between the image and the reference image, the message may indicate that the milestone in navigating the geographic route has been achieved. Otherwise, the message may indicate that the milestone in navigating the geographic route has not been achieved and/or remedial action that the user can take.

In some embodiments, server 212 optionally provides the one or more additional messages to electronic device 210 via network 410.

After electronic device 210 has received the message and/or the one or more additional messages, the software application may display the content associated with the message and/or the one or more additional messages. Alternatively or additionally, the software application may communicate the content to the user (e.g., using sound waves that convey audio information).

Note that information in system 400 may be stored at one or more locations in system 400 (i.e., locally or remotely). Moreover, because this data may be sensitive in nature, it may be encrypted. For example, stored data and/or data communicated via network 410 may be encrypted.

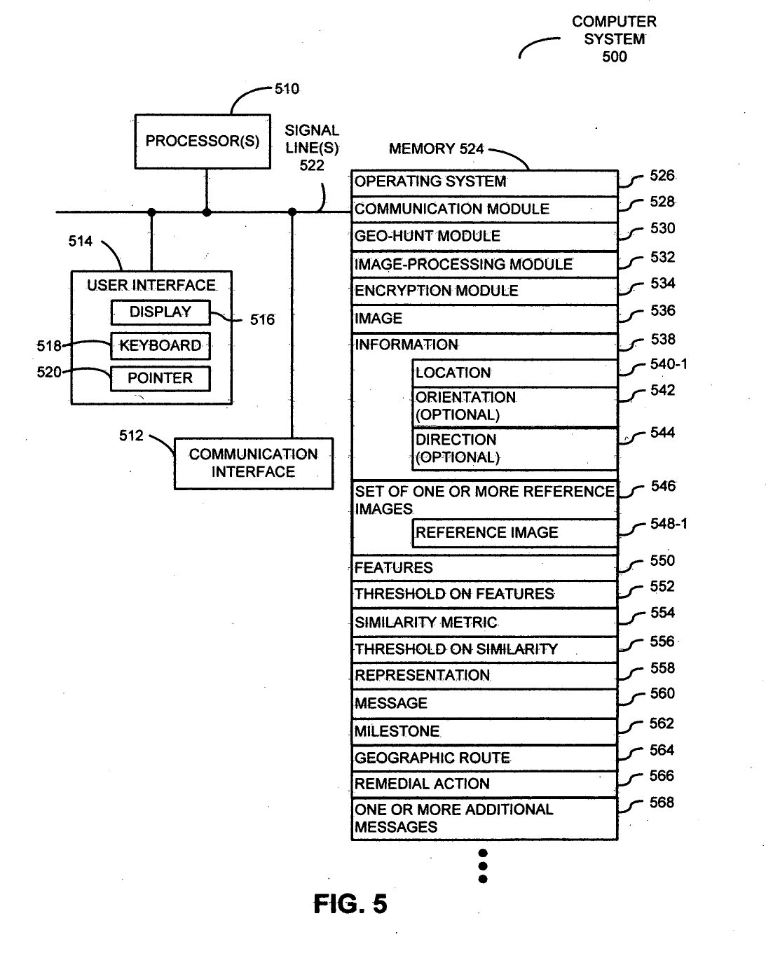

FIG. 5 presents a block diagram illustrating a computer system 500 that performs method 100 (FIGS. 1 and 2), such as server 212 (FIGS. 2 and 4). Computer system 500 includes one or more processing units or processors 510, a communication interface 512, a user interface 514, and one or more signal lines 522 coupling these components together. Note that the one or more processors 510 may support parallel processing and/or multi-threaded operation, the communication interface 512 may have a persistent communication connection, and the one or more signal lines 522 may constitute a communication bus. Moreover, the user interface 514 may include: a display 516, a keyboard 518, and/or a pointer 520, such as a mouse.

Memory 524 in computer system 500 may include volatile memory and/or non-volatile memory. More specifically, memory 524 may include: ROM, RAM, EPROM, EEPROM, flash memory, one or more smart cards, one or more magnetic disc storage devices, and/or one or more optical storage devices. Memory 524 may store an operating system 526 that includes procedures (or a set of instructions) for handling various basic system services for performing hardware-dependent tasks. Memory 524 may also store procedures (or a set of instructions) in a communication module 528. These communication procedures may be used for communicating with one or more computers and/or servers, including computers and/or servers that are remotely located with respect to computer system 500. In addition, memory 524 may store one or more data structures and/or databases.

Memory 524 may also include multiple program modules (or sets of instructions), including: geo-hunt module 530 (or a set of instructions), image-processing module 532 (or a set of instructions) and/or encryption module 534 (or a set of instructions). Note that one or more of these program modules (or sets of instructions) may constitute a computer-program mechanism.

During the communication technique, geo-hunt module 530 may receive image 536 from electronic device 210 via communication interface 512 and communication module 528. Moreover, geo-hunt module 530 may receive information 538 specifying: location 540-1 where image 536 was acquired, an optional orientation 542 of electronic device 210 when image 536 was acquired, and/or an optional direction 544 of electronic device 210 when image 536 was acquired. In addition, while not shown, information 538, may also include an altitude and/or a timestamp.

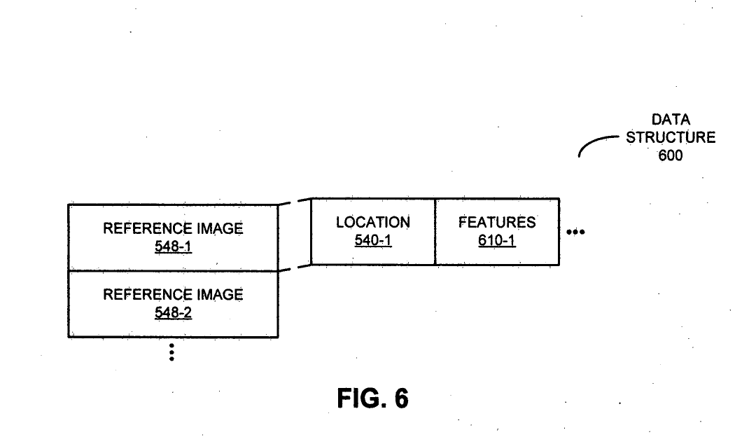

In response to receiving image 536, geo-hunt module 530 may access reference image 548-1 in predefined set of one or more reference images 546 based on location 540-1. FIG. 6 presents a block diagram illustrating a data structure 600 with reference images 548. In particular, data structure 600 may include locations (such as location 540-1) and features 610 in reference images 548. As noted previously, features 610 may be used to identify potential matches with references images 548. Note that reference images 546 (FIG. 5) and data structure 600 may include similar information and data as information 538 (FIG. 5).

Referring back to FIG. 5, image-processing module 532 may optionally perform the one or more operations, such as: image processing image 536 to extract features 550, modifying image 536, and/or selecting the pixels associated with the wavelength of light in image 536 (or a distribution of wavelengths of light in the image).

Moreover, image-processing module 532 may compare image 536 to reference image 548-1. For example, image-processing module 532 may: apply threshold on features 552 to extracted edges in features 550, rotate image 536, scale image 536, extract features 550 from image 536, calculate similarity metric 554 between features 550 or features 610 (FIG. 6) in reference image 548-1 (such as a mean-square difference), determine if the match is achieved based on similarity metric 554 and threshold on similarity 556, and/or transform representation 558 of image 536.

Furthermore, geo-hunt module 530 may provide message 560 to electronic device 210 via communication module 528 and communication interface 512. For example, if the comparison indicates a match between image 536 and reference image 548-1, message 560 may indicate that milestone 562 in navigating geographic route 564 (corresponding to predefined set of one or more reference images 546) has been achieved. Otherwise, message 560 may indicate that milestone 562 in navigating geographic route 564 has not been achieved and/or remedial action 566 that the user can take (such as instructions on how to acquire another image of location 540-1 to obtain the match).

In some embodiments, geo-hunt module 530 optionally provides one or more additional message 568 to electronic device 210 via communication module 528 and communication interface 512. For example, the one or more additional messages 568 may indicate the competitive state of the other individual participating in the geo-hunt and/or may provide the hint.

Because information used in the communication technique may be sensitive in nature, in some embodiments at least some of the data stored in memory 524 and/or at least some of the data communicated using communication module 528 is encrypted and/or decrypted using encryption module 534.

Instructions in the various modules in memory 524 may be implemented in: a high-level procedural language, an object-oriented programming language, and/or in an assembly or machine language. Note that the programming language may be compiled or interpreted, e.g., configurable or configured, to be executed by the one or more processors 510. In the present discussion, ‘configured’ should be understood to encompass pre-configured prior to execution by one or more processor 510, as well as ‘configurable,’ i.e., configured during or just before execution by one or more processor 510.

Although computer system 500 is illustrated as having a number of discrete items, FIG. 5 is intended to be a functional description of the various features that may be present in computer system 500 rather than a structural schematic of the embodiments described herein. In some embodiments, some or all of the functionality of computer system 500 may be implemented in one or more application-specific integrated circuits (ASICs) and/or one or more digital signal processors (DSPs).

Computer system 500, as well as electronic devices, computers and servers in system 500, may include one of a variety of devices capable of manipulating computer-readable data or communicating such data between two or more computing systems over a network, including: a personal computer, a laptop computer, a tablet computer, a mainframe computer, a portable electronic device (such as a cellular telephone or PDA), a server, a point-of-sale terminal and/or a client computer (in a client-server architecture). Moreover, network 410 (FIG. 4) may include: the Internet, World Wide Web (WWW), an intranet, a cellular-telephone network, LAN, WAN, MAN, or a combination of networks, or other technology enabling communication between computing systems.

Electronic device 210 (FIGS. 2 and 4), server 212 (FIGS. 2 and 4), system 400 (FIG. 4), computer system 500 and/or data structure 600 (FIG. 6) may include fewer components or additional components. Moreover, two or more components may be combined into a single component, and/or a position of one or more components may be changed. In some embodiments, the functionality of electronic device 210 (FIGS. 2 and 4), server 212 (FIGS. 2 and 4), system 400 (FIG. 4) and/or computer system 500 may be implemented more in hardware and less in software, or less in hardware and more in software, as is known in the art.

In the preceding description, we refer to ‘some embodiments.’ Note that ‘some embodiments’ describes a subset of all of the possible embodiments, but does not always specify the same subset of embodiments.

While comparing the image with the reference image during an image-based geo-hunt was used as an illustration of the communication technique, in other embodiments the communication technique may be used to provide feedback on a wide variety of types of content or information, including: audio information, video information, alphanumeric characters (such as text on a sign proximate to the location), etc.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer-implemented method for providing feedback, the method comprising:
receiving an image and information specifying a location of an electronic device when the image was captured;
accessing a reference image, associated with a second location, in a predefined set of one or more reference images stored in a computer-readable memory based on the location, wherein the predefined set of one or more reference images are associated with a set of one or more locations along a geographic route that includes the second location, and wherein the location is at least proximate to the second location;
using the computer, comparing the image to the reference image;
if the comparison indicates a match between the image and the reference image, providing a message indicating that a milestone in navigating the geographic route has been achieved; and
otherwise, providing a second message indicating that the milestone in navigating the geographic route has not been achieved.

2. The method of claim 1, wherein the information specifying the location is based on at least one of: a local positioning system, a global position system, triangulation, trilateration, and an address, associated with the electronic device, in a network.

3. The method of claim 1, wherein the information further specifies at least one of: an orientation of the electronic device when the image was acquired, and a direction of the electronic device when the image was acquired.

4. The method of claim 3, wherein, prior to the comparison, the method further comprises modifying the image to correct for one of: a light intensity, a location of a light source, color variation in the image, the orientation of the electronic device, the direction of the electronic device, natural changes based on a difference between a timestamp associated with the image and a timestamp associated with the reference image, and a difference in a composition of the image and a composition of the reference image.

5. The method of claim 1, wherein, prior to the comparison, the method further comprises image processing the image to extract features; and
wherein the comparison is based on the extracted features.

6. The method of claim 5, wherein the features include one of: edges associated with objects, corners associated with the objects, lines associated with objects, conic shapes associated with objects, color regions within the image, and texture associated with objects.

7. The method of claim 6, wherein the comparing involves applying a threshold to the extracted edges to correct for variation in intensity in the image and the reference image.

8. The method of claim 1, wherein the information further specifies features in the image.

9. The method of claim 1, wherein, prior to the comparison, the method further comprises selecting pixels associated with one of: a wavelength of light in the image, and a distribution of wavelengths of light in the image; and
wherein the comparison is based on the selected pixels.

10. The method of claim 1, wherein location is different from the second location.

11. The method of claim 1, wherein the comparing involves:
rotating the image so that an orientation of the image matches an orientation of the reference image;
scaling the image so that a length corresponding to first features in the image matches a second length corresponding to second features in the reference image;
extracting the first features from the image;
calculating a similarity metric between the first features and the second features; and
determining if the match is achieved based on the similarity metric and a threshold.

12. The method of claim 1, wherein the comparing involves transforming a representation of the image from rectangular coordinates to log-polar coordinates.

13. The method of claim 1, wherein the message specifies information associated with a subsequent location in the set of one or more locations.

14. The method of claim 1, wherein the second message includes instructions on how to acquire another image of the location to obtain the match.

15. The method of claim 1, wherein the method further comprises providing a third message that indicates a competitive state of another member of a group navigating the geographic route.

16. The method of claim 1, wherein the method further comprises providing a third message that offers an opportunity to purchase a hint that includes one of: instructions on how to navigate the geographic route; instructions on how to acquire another image of the location to obtain the match; and information associated with a subsequent location in the set of one or more locations.

17. The method of claim 1, wherein, prior to the receiving, the method further comprises receiving the set of reference images and the associated set of one or more locations along the geographic route.

18. The method of claim 17, wherein, prior to the receiving, the method further comprises receiving metadata associated with the set of reference images.

19. A computer-program product for use in conjunction with a computer system, the computer-program product comprising a non-transitory computer-readable storage medium and a computer-program mechanism embedded therein to provide feedback, the computer-program mechanism including:
instructions for receiving an image and information specifying a location of an electronic device when the image was captured;
instructions for accessing a reference image, associated with a second location, in a predefined set of one or more reference images stored in a computer-readable memory based on the location, wherein the predefined set of one or more reference images are associated with a set of one or more locations along a geographic route that includes the second location, and wherein the location is at least proximate to the second location;
instructions for comparing the image to the reference image;
if the comparison indicates a match between the image and the reference image, instructions for providing a message indicating that a milestone in navigating the geographic route has been achieved; and
otherwise, instructions for providing a second message indicating that the milestone in navigating the geographic rote has not been achieved.

20. A computer system, comprising:
a processor;
memory; and
a program module, wherein the program module is stored in the memory and configured to be executed by the processor to provide feedback, the program module including:
instructions for receiving an image and information specifying a location of an electronic device when the image was captured;
instructions for accessing a reference image, associated with a second location, in a predefined set of one or more reference images stored in a computer-readable memory based on the location, wherein the predefined set of one or more reference images are associated with a set of one or more locations along a geographic route that includes the second location, and wherein the location is at least proximate to the second location;
instructions for comparing the image to the reference image;
if the comparison indicates a match between the image and the reference image, instructions for providing a message indicating that a milestone in navigating the geographic route has been achieved; and
otherwise, instructions for providing a second message indicating that the milestone in navigating the geographic route has not been achieved.
